(19) United States
(12) Patent Application Publication
(10) Pub. No.: US 2025/0360915 A1
(43) Pub. Date: Nov. 27, 2025

(54) VEHICLE CONTROL METHOD WITH STEERING ANGLE CORRECTION

(71) Applicant: ZF CV Systems Global GmbH, Bern (CH)

(72) Inventors: Klaus Plähn, Seelze (DE); Oliver Wulf, Neustadt (DE); Benjamin Bieber, Wedemark (DE); Jonas Böttcher, Hannover (DE)

(21) Appl. No.: 19/267,294

(22) Filed: Jul. 11, 2025

Related U.S. Application Data
(63) Continuation of application No. PCT/EP2024/050032, filed on Jan. 2, 2024.

(30) Foreign Application Priority Data
Jan. 13, 2023 (DE) 10 2023 100 750.5

(51) Int. Cl. B60W 30/045; B60W 10/08; B60W 10/20

(52) U.S. Cl. CPC B60W 30/045; B60W 10/08; B60W 10/20; B60W 2300/14; B60W 2520/06; B60W 2520/10; B60W 2520/14; B60W 2710/083; B60W 2720/14; B60W 2720/24

(57) ABSTRACT

A vehicle control method includes early detection of an unstable driving state of a vehicle at least using an actual variable and a setpoint trajectory; wherein it is ascertained during early detection whether the unstable driving state is understeering of the vehicle or oversteering of the vehicle; and in response to the early detection: definition of a steering angle correction for a setpoint steering angle, wherein the steering angle correction includes a steering-angle limitation of an actual steering angle that can be provided if the unstable driving state is understeering of the vehicle, and wherein the steering angle correction includes a countersteering angle directed counter to the setpoint steering angle if the unstable driving state of the vehicle is oversteering; and steering of the vehicle using the steering angle correction. A vehicle control system, a vehicle and a computer program product are configured to perform the method.

### CROSS-REFERENCE TO RELATED APPLICATIONS

This application is a continuation application of international patent application PCT/EP2024/050032, filed Jan. 2, 2024, designating the United States and claiming priority from German application 10 2023 100 750.5, filed Jan. 13, 2023, and the entire content of both applications is incorporated herein by reference.

### TECHNICAL FIELD

The disclosure relates to a vehicle control method for a vehicle having an electronically controllable steering system. Furthermore, the disclosure relates to a vehicle control system, a vehicle and a computer program product.

### BACKGROUND

The autonomization of vehicles is one of the important fields of development of the modern automotive industry. Semi-autonomous vehicles take over subtasks in the control of the vehicle, while autonomous vehicles are controlled completely without human intervention. Thus, autonomous vehicles control the lateral and longitudinal guidance of the vehicle completely independently of a human user. Semi-autonomous vehicles conversely only take over subtasks in the control of the vehicle. In the context of the further increasing autonomization of vehicles, the vehicles are more and more frequently also taking over steering tasks, such as lane keeping or distance control for example. While autonomous vehicles always have an electronically controllable steering system, such a steering system can also be provided in semi-autonomous vehicles, for example if the vehicle has a lane-keeping assistance system which keeps the vehicle inside a lane automatically. An electronically controllable steering system controls the vehicle at least to some extent based on electrical signals.

Thus, an autonomous control unit, which is also referred to as a virtual driver, can specify a steering request at the electronically controllable steering system, which then brings about cornering of the vehicle or steers the vehicle. For steering, the virtual driver can specify a steering request (for example a steering angle) at the electronically controllable steering system or else provide a setpoint trajectory at a steering control system, from which the steering control system then derives a corresponding steering request. The setpoint trajectory at least includes the driving path which the vehicle should follow. Furthermore, the setpoint trajectory can however also include further information, such as a speed profile for example, which specifies a setpoint speed of the vehicle for one or more points along the driving path. Furthermore, the setpoint trajectory can also include further setpoints, such as an orientation of the vehicle, particularly a course angle, a yaw rate that is assigned to one or more points of the driving path, and/or a steering angle.

Owing to different influences, it may come to pass that the vehicle does not follow the specified setpoint trajectory or a trajectory deviation arises. The vehicle then does not move along the driving path encompassed by the trajectory, but rather offset to it or with a different orientation.

The virtual driver or a position controller of the vehicle, which may also be part of the virtual driver, attempts to compensate a trajectory deviation using the electronically controllable steering system, which can also be referred to as an active steering system. When cornering, in the case of a lateral deviation of the vehicle toward the outside of a bend, the position controller will attempt to compensate this lateral deviation via stronger turn-in (increasing the steering angle toward the inside of the bend). In the case of adverse road conditions, this will not succeed, as the vehicle does not react to steering settings in the manner that the position controller expects. So, in the case of adverse road and/or weather conditions, the vehicle may not be able to drive on a specified bend, as lateral guiding forces that are built up between the tires of the vehicle and the roadway that is driven on are not sufficient to guide the vehicle counter to the inertia along the required course curvature of the driving path. Particularly if there is already yaw instability, that is, understeering or oversteering of the vehicle, it is not possible under certain circumstances to compensate the trajectory deviation by increasing the steering setting. Known virtual drivers and/or position controllers are not configured to control automated or autonomous vehicles safely in all situations. In cases in which a known position controller cannot compensate the trajectory deviation, the intervention of a conventional stability control system, such as what is known as an electronic stability control (ESC) in particular, is necessary. Owing to the specified intervention thresholds of stability control systems, an intervention of this type only takes place in the event of large instabilities of the vehicle and therefore very late. The space requirement is increased and the risk of accidents increases. Furthermore, under certain circumstances, the vehicle can no longer react at all to a change or variation of the steering angle in the case of instability and further steering by the position controller can even worsen the stability of the vehicle, particularly in the case of understeering of the vehicle. Furthermore, countersteering that is too late and/or incorrect can also further worsen the stability of the vehicle in the case of an oversteering vehicle.

DE 10 2020 117 322 A1 discloses a vehicle system for a vehicle having an electronically controllable steering device. In the event of the failure of an electronic stability control system during the drive, the electronically controllable steering device performs laterally stabilizing steering interventions to keep the vehicle within a tolerance corridor of a specified setpoint trajectory of the vehicle. The steering interventions compensate individual wheel braking, which is no longer present, at axles which are then activated on a per-axle basis owing to the failure of the electronic stability control system. The system creates a fallback level when an electronic stability control system of a primary system is no longer available. The disclosed system thus relates to a fallback level for a conventional stability control system and does not enable early stabilizing interventions. Furthermore, the steering interventions are used to keep the vehicle in a tolerance corridor, so a trajectory deviation is accepted.

### SUMMARY

There is a requirement for vehicle control methods which overcome the previously mentioned disadvantages. It is an object of the present disclosure is to specify a vehicle control method in which instabilities are detected early and steering of the vehicle takes place in a manner adequate for the situation.

The disclosure achieves the object in a vehicle control method of the kind mentioned in the introduction, including: ascertainment of a setpoint trajectory for the vehicle; ascertainment of a setpoint steering angle for driving on the setpoint trajectory; early detection of an unstable driving state of the vehicle at least using the setpoint trajectory; wherein it is ascertained during early detection whether the unstable driving state is understeering of the vehicle or oversteering of the vehicle; and in response to the early detection of the unstable driving state: definition of a steering angle correction for the setpoint steering angle, wherein the steering angle correction includes a steering-angle limitation of an actual steering angle that can be provided by the electronically controllable steering system if the unstable driving state is understeering of the vehicle, and wherein the steering angle correction includes a countersteering angle directed counter to the setpoint steering angle if the unstable driving state of the vehicle is oversteering; and steering of the vehicle using the steering angle correction.

The disclosure is based on the one hand on the idea that unstable driving states can be detected early using the setpoint trajectory and on the other hand on the discovery that the measures taken by a position controller and/or virtual driver to compensate an unstable driving state may be unsuitable for eliminating the unstable driving state. By intervening early, it is possible to prevent dangerous situations. The steering angle correction corrects the steering angle belonging to the setpoint trajectory. As a consequence of the steering angle correction, the vehicle can be stabilized and/or the steering angle correction prevents steering interventions which promote the unstable driving state.

The setpoint trajectory is preferably provided by a unit for autonomous driving, particularly a virtual driver, for example via a vehicle bus. Preferably, the vehicle control method includes carrying out trajectory planning to obtain the setpoint trajectory. The setpoint steering angle is the steering angle of the vehicle which the virtual driver or another autonomous unit predicts for driving on the setpoint trajectory, wherein the virtual driver assumes stable handling characteristics of the vehicle. Preferably, the setpoint steering angle is encompassed by the setpoint trajectory. The setpoint trajectory then includes not only the driving path to be driven on, but also the setpoint steering angle that is predicted for driving on this driving path. Preferably, the ascertainment of the setpoint steering angle takes place in a model-based manner. For example, the virtual driver can ascertain a setpoint steering angle that is to be specified on the basis of a vehicle model when ascertaining the setpoint trajectory. The vehicle model can be a single-lane model of the vehicle. The ascertainment of the setpoint steering angle can take place using a speed of the vehicle or a speed profile of the vehicle when driving on the setpoint trajectory, wherein the speed and/or the speed profile can be encompassed by the setpoint trajectory. The actual variable is a variable which is set when driving on the trajectory or in the driving situation to which the setpoint trajectory belongs.

The early detection of an unstable driving state of the vehicle takes place at least using the actual variable and the setpoint trajectory. So, in contrast to previously known methods, instabilities are not first detected when various vehicle sensors report strong actual deviations from previously defined threshold values. The setpoint trajectory is taken into consideration according to the disclosure and allows detection of an instability which is adapted to the respective driving situation. Thus, an unstable driving state can be detected early for example if the actual variable deviates by more than a tolerance dimension from the setpoint trajectory or from a variable that is derived from the setpoint trajectory. The unstable driving state may be oversteering or understeering of the vehicle. Oversteering and understeering are common terms for describing the handling characteristics of vehicles. In the case of understeering, the so-called understeer gradient of the vehicle is greater than zero, it must therefore be steered more strongly in order to follow a bend than in the case of a neutral vehicle. The oversteering of the vehicle is also frequently referred to colloquially as breakaway of the vehicle.

The steering angle correction is defined in response to the early detection of the unstable driving state. In the case of understeering, the steering angle correction includes a steering-angle limitation of the actual steering angle that can be provided. During understeering, the vehicle deviates from the planned driving path toward the outside of a bend. The position controller of the vehicle will continuously increase the actual steering angle, that is, turn in more strongly, in an effort to follow the planned driving path. The setpoint steering angle that would be necessary in the case of stable driving is exceeded. Above a particular limit value for the tire slip of the front wheels, this no longer makes sense however, since the tires can no longer apply further lateral guiding forces. This is often the case if the adhesion between tires and roadway is reduced, for example in the case of wetness or slipperiness. If the adhesion between tires and roadway suddenly increases again in the case of a large actual steering angle, then the steered wheels abruptly build up high lateral guiding forces and the vehicle may become uncontrollable. In the method according to the disclosure, a steering-angle limitation is defined in the case of understeering, so that this danger is eliminated. The vehicle is steered using the steering angle correction so that it is not possible to specify an actual steering angle which exceeds a reasonable or safe dimension. Thus, the steering-angle limitation may for example be a limitation of a maximum actual steering angle that can be provided by the electronically controllable steering system to 30°.

In the case of oversteering, the vehicle turns in more strongly than is necessary for driving on the current driving path. In the process, the vehicle generally also leaves the planned driving path. However, in the case of an oversteering vehicle, the position controller and/or autonomous driver must not adapt the steering angle primarily to the offset of the vehicle from the planned driving path in order to return to it. Thus, in the case of a lateral deviation of the vehicle toward the outside of a bend, a pure adaptation to the position deviation would lead to the actual steering angle being increased further in the direction of the course of the bend, as a result of which the oversteering would be amplified further. Instead, the vehicle reaction should be adapted to the excessive yaw rate and this should be damped in an appropriate manner by countersteering. In the method according to the disclosure, this takes place in that the steering angle correction includes a countersteering angle directed counter to the setpoint steering angle, which is directed toward the inside of a bend. When steering the vehicle using the steering angle correction, the countersteering angle counteracts the setpoint steering angle and the vehicle is stabilized. The countersteering angle that counteracts the setpoint steering angle has the opposite sign to the actual steering angle. If the actual steering angle is for example positive (that is, measured counterclockwise), then the countersteering angle is a negative angle (measured clockwise).

In a first embodiment, the method further includes in response to the early detection of the unstable driving state: individual wheel deceleration of at least one wheel of the vehicle. In addition to the steering angle correction, the method in the embodiment therefore additionally includes individually decelerating at least one wheel of the commercial vehicle. This individual wheel deceleration is preferably used for providing a yaw moment on the vehicle. Thus, as a consequence of the steering-angle limitation or other factors, such as for example a low coefficient of friction between vehicle and roadway, it is possible to limit a yaw rate of the vehicle that can be achieved by steering. The individual wheel deceleration can compensate a difference between a setpoint yaw rate and the yaw rate that can be set by the steering system. Preferably, to decelerate the wheel, brake slip is set at the wheel that is to be decelerated. This can take place for example by providing a braking pressure at a brake actuator that is assigned to the wheel. The wheel that is to be decelerated can however also be decelerated by recuperation for example. A wheel that is decelerated individually is decelerated independently of the remaining wheels of the vehicle. It may be provided however that two or more wheels of the vehicle are decelerated simultaneously to the same extent. Thus, all wheels of a vehicle that are oriented toward a center point of a bend (that is, all wheels on the inside of the bend) can for example be decelerated to the same extent. Of course, it is however also possible for only a single wheel to be decelerated. Thus, to compensate oversteering for example, a front wheel of the vehicle on the outer side of the bend can be decelerated, in order to provide a yaw moment that counteracts the oversteering. The necessary controlled variable for deceleration and/or the selection of the correct wheel preferably takes place using the setpoint trajectory and the actual variable. Unlike in a conventional stability control system (ESC), in which the intensity of the intervention is proportioned solely via the steering system, a setpoint variable is also taken into consideration in this manner. Due to the individual wheel deceleration, an additional yaw moment is preferably provided, which acts in the direction of the steering angle correction. In the case of understeering, the steering angle correction or the steering-angle limitation acts in the direction of the setpoint steering angle. The steering angle correction therefore counteracts a yawing of the vehicle toward the outside of a bend. In the case of oversteering, the countersteering angle acts toward the outside of a bend, so that the yaw moment provided by the individual wheel deceleration counteracts an excessive turning of the vehicle toward the inside of a bend. Preferably, the individual wheel deceleration does not take place in a per-axle manner. Wheels of the commercial vehicle belonging to the same axle are therefore not decelerated uniformly.

Preferably, the at least one wheel of the vehicle is a wheel of the commercial vehicle on the inner side of a bend, particularly a rear wheel of the commercial vehicle on the inside of a bend, if the unstable driving state of the commercial vehicle is understeering. The at least one wheel of the commercial vehicle is preferably a wheel of the commercial vehicle on the outer side of a bend, particularly a wheel on the front axle of the commercial vehicle on the outer side of a bend, if the unstable driving state of the commercial vehicle is oversteering.

Furthermore, it is preferred that the steering-angle limitation corresponds to the setpoint steering angle plus a steering-angle supplement if the unstable driving state is understeering of the vehicle. By taking a fixed or variable steering-angle supplement into consideration, the steering-angle limitation can be defined particularly easily. The steering-angle supplement is preferably ascertained taking the setpoint trajectory into consideration. Thus, the steering-angle supplement can be chosen to be larger in the case of strong curvature of the driving path or high speeds than in the case of a setpoint trajectory which corresponds to a slow drive of the vehicle. The setpoint steering angle is preferably an Ackermann steering angle which is ascertained from a radius of curvature of the trajectory and a wheelbase of the vehicle. Preferably, the setpoint steering angle can also take a build-up of force of the tires into consideration. It can accordingly be provided that the setpoint steering angle takes an entry distance of the tire during cornering into consideration, which entry distance is required to build up the lateral guiding forces in the contact area between tire and roadway.

According to a further embodiment, the steering-angle supplement is ascertained using surface information of a roadway, which is preferably encompassed by the setpoint trajectory. The setpoint trajectory can for example include surface information which characterizes a smooth roadway with a considerably reduced coefficient of friction. It may however also be provided that the surface information is provided separately. An optimum tire slip angle at which wheels of the vehicle can effect a maximum lateral guidance of the vehicle depends on the surface of the roadway or a coefficient of friction between the wheels of the vehicle and the roadway on which the vehicle is driving. In the case of slipperiness due to ice, the optimum tire slip angle has a lower value than on a rough dry roadway. Thus, in the case of an icy roadway, even in the case of small actual steering angles, it is no longer possible to build up further lateral guiding forces. Steering-angle limitation is therefore preferably stronger in the case of an icy roadway or the steering-angle supplement is lower than in the case of a dry roadway, as a further increase of the steering angle is no longer reasonable under certain circumstances, even in the case of comparatively small steering angles.

Preferably, the method further includes: monitoring of a situation of the vehicle; ascertainment of a trajectory deviation of the vehicle using the setpoint trajectory and the monitored situation; and ascertainment of a rate of change of trajectory deviation. When monitoring the situation of the vehicle, the situation of the vehicle is preferably ascertained continuously or at discrete time intervals. By monitoring the situation, a change in the situation of the vehicle can be ascertained. The situation preferably includes the position of the vehicle. Furthermore, the situation can however alternatively or additionally also include an orientation of the vehicle, particularly a course angle. The course angle designates an angle between the direction of geographic north and the target direction of the vehicle. If the vehicle is driving east for example, the vehicle is moving with a course angle of 90°. The course angle can however also be an angle in a vehicle-fixed coordinate system. The trajectory deviation is a deviation of the situation of the vehicle from the trajectory. The trajectory deviation preferably is or includes a positional deviation of the vehicle between an actual position of the vehicle and a setpoint position of the vehicle on the driving path. One example for a positional deviation is a lateral deviation of the vehicle from the driving path lateral to the driving direction. The trajectory deviation can however also be or include a course angle deviation between an actual course angle of the vehicle and a setpoint course angle. The rate of change of trajectory deviation indicates the change over time of the trajectory deviation. The rate of change of trajectory deviation preferably describes the change of the trajectory deviation over a particular time period in relation to the duration of this time period. The time period considered is preferably short. The duration of the time period is preferably 10 s (seconds) or less, preferably 8 s or less, preferably 6 s or less, preferably 5 s or less, preferably 4 s or less, preferably 3 s or less, preferably 2 s or less, preferably 1 s or less. An increasing trajectory deviation is an indicator that an unstable driving state is present. An increasing rate of change of trajectory deviation is present for example if the vehicle understeers during cornering and, as a consequence of that, a lateral deviation of the vehicle (that is, an offset of the vehicle lateral to the vehicle path) steadily increases. The ascertainment of the rate of change of trajectory deviation enables a particularly simple early detection of the unstable driving state. So, starting from a state in which the vehicle is driving on the driving path, even the development of a small positional deviation brings about an increasing rate of change of trajectory deviation. Thus, an unstable driving state can be detected even in the case of small absolute trajectory deviations and/or if a virtual driver has still not carried out a steering intervention under certain circumstances. Conventional stability control systems react to steering interventions such that these stability control systems can only detect unstable driving states if steering is taking place. Unstable driving states can therefore be detected considerably earlier via a rate of change of trajectory deviation than in the case of conventional stability control systems. It should however be understood that the ascertainment of a rate of change of trajectory deviation is a preferred and not a necessary step of an early detection of an unstable driving state using the setpoint trajectory.

In an embodiment, the actual variable is an actual yaw rate and the early detection of an unstable driving state of the vehicle at least using the actual variable and the setpoint trajectory includes: ascertainment of a setpoint yaw rate for the vehicle using the setpoint trajectory; ascertainment of an actual yaw rate for the vehicle; and ascertainment of an unstable driving state if the actual yaw rate is outside a yaw-rate tolerance range around the setpoint yaw rate. Preferably, the ascertainment of an actual yaw rate is or includes measurement of the actual yaw rate, preferably using a yaw-rate sensor of the vehicle. The ascertainment of the actual yaw rate can however also be ascertainment of the actual yaw rate using signals which are provided on a vehicle network, preferably a vehicle bus, particularly preferably a CAN bus. So, a stability control system, particularly an ESC control unit, can for example and preferably provide signals, which represent the actual yaw rate of the vehicle, on the vehicle network. The yaw-rate tolerance range defines a range of values around the setpoint yaw rate. The setpoint yaw rate is a yaw rate of the vehicle which is predicted for the setpoint trajectory. Preferably a deceleration dimension for the deceleration of the at least one wheel is ascertained on the basis of a dimension of the deviation of the actual yaw rate from the setpoint yaw rate. The deceleration dimension is preferably a wheel slip request for the at least one wheel.

Preferably, understeering of the commercial vehicle is ascertained if the magnitude of the actual yaw rate is below the yaw-rate tolerance range and oversteering of the vehicle is ascertained if the magnitude of the actual yaw rate is above the yaw-rate tolerance range. The actual yaw rate is below the yaw-rate tolerance range if the magnitude of the actual yaw rate is less than the magnitude of the setpoint yaw rate and the actual yaw rate is not in the yaw-rate tolerance range. Analogously, the actual yaw rate is above the yaw-rate tolerance range if the magnitude of the actual yaw rate is greater than the magnitude of the setpoint yaw rate and the actual yaw rate is not in the yaw-rate tolerance range. The actual yaw rate and the setpoint yaw rate are preferably considered in terms of magnitude. If the magnitude of the actual yaw rate is below the yaw-rate tolerance range, then the vehicle is understeering. Conversely, if the magnitude of the actual yaw rate is above the yaw-rate tolerance range, then the vehicle is oversteering. An advantage of consideration in terms of magnitude is that the method can be applied for left-hand bends and right-hand bends.

In an embodiment, understeering or oversteering is only ascertained if the rate of change of trajectory deviation characterizes an increasing trajectory deviation of the vehicle from the setpoint trajectory. Understeering is therefore only ascertained according to the embodiment if the actual yaw rate is below the yaw-rate tolerance range and the trajectory deviation is increasing. Analogously, oversteering is only ascertained in the embodiment if the actual yaw rate is above the yaw-rate tolerance range and the trajectory deviation is increasing. The ascertainment of an unstable driving state thus becomes more robust and a risk of erroneous ascertainment is minimized. So, incorrect ascertainment can be excluded for example in cases in which the vehicle drives into a bend already with a lateral deviation from the driving path encompassed by the setpoint trajectory, but then follows the bend in a stable manner with constant lateral deviation.

Preferably, the ascertainment of the setpoint yaw rate for the vehicle using the setpoint trajectory includes: ascertainment of a curvature of the setpoint trajectory; ascertainment of an actual speed of the vehicle; and ascertainment of the setpoint yaw rate at least using the curvature of the setpoint trajectory and the actual speed of the vehicle.

Preferably, the yaw-rate tolerance range has a width of ±0.1°/s to ±10° /s, preferably ±0.1° /s to ±8° /s, preferably ±0.3° /s to ±8° /s, preferably ±0.3° /s to ±6° /s, preferably ±0.3° /s to ±5° /s, preferably ±0.3° /s to ±4° /s, preferably ±0.4° /s to ±4° /s, preferably ±0.5° /s to ±4° /s, preferably ±0.5° /s to ±3° /s, preferably ±0.5° /s to ±2° /s, around the value of the setpoint yaw rate. Preferably, the yaw-rate tolerance range has a width of ±6° /s or less, preferably ±5° /s or less, preferably ±4° /s or less, preferably ±3° /s or less, preferably ±2° /s or less, particularly preferably ±1.5° /s or less, around the value of the setpoint yaw rate. If, for example, the setpoint yaw rate has a magnitude of 10° /s and the yaw-rate tolerance range has a width of ±1.5° /s, then an unstable driving state is ascertained if the magnitude of the actual yaw rate is less than or equal to 8.5° /s (understeering) or if the magnitude of the actual yaw rate is greater than or equal to 11.5° /s (oversteering). Preferably, the yaw-rate tolerance range can also be ascertained dynamically. Thus, the yaw-rate tolerance range can preferably be defined depending on the curvature of the setpoint trajectory, wherein a large curvature results in a wide yaw-rate tolerance range and a small curvature results in a narrow yaw-rate tolerance range. Preferably, the yaw-rate tolerance range has a minimum width, below which a value must not fall even in the case of a missing curvature (in the case of a straight-lined distance).

In a variant, the countersteering angle is ascertained using a yaw-rate deviation between the actual yaw rate and the setpoint yaw rate if the unstable driving state is oversteering. The yaw-rate deviation is preferably ascertained from the magnitude of the actual yaw rate and the magnitude of the setpoint yaw rate. The yaw-rate deviation is then independent of the direction of a bend. By using the yaw-rate deviation to ascertain the countersteering angle, it is possible to counteract oversteering particularly effectively. A large yaw-rate deviation then also entails a large countersteering angle. Thus, if the vehicle breaks away strongly for example, then strong countersteering is also performed.

According to an embodiment, the actual variable is the actual steering angle and the early detection of an unstable driving state of the vehicle at least using the actual variable and the setpoint trajectory includes: carrying out a variance comparison between the actual steering angle and the setpoint steering angle; and early detection of the unstable driving state if a trajectory deviation is ascertained and the actual steering angle deviates from the setpoint steering angle at least by a steering-angle tolerance value. It should be understood that the early detection of an unstable driving state can take place on the basis of the actual steering angle and on the basis of the actual yaw rate. So an unstable driving state can only be ascertained for example if the actual yaw rate is outside the yaw-rate tolerance range and the actual steering angle deviates from the setpoint steering angle by the steering-angle tolerance value. A deviation between the actual steering angle and the setpoint steering angle is an indicator that the position controller and/or virtual driver of the vehicle is attempting to compensate a trajectory deviation. Thus, an unstable driving state can advantageously be detected particularly early. Preferably, an early detection of understeering and/or oversteering only takes place if the actual steering angle deviates from the setpoint steering angle at least by a steering-angle tolerance value in a direction that counteracts the trajectory deviation. The actual steering angle deviates from the setpoint steering angle in a direction that counteracts the trajectory deviation if the actual steering angle is provided to compensate the trajectory deviation. In the case of understeering of the vehicle, the actual steering angle deviates in a direction that counteracts the trajectory deviation if the actual steering angle is greater in terms of magnitude than the setpoint steering angle and has the same sign. Owing to the steering-angle tolerance value, only significant deviations of the actual steering angle from the setpoint steering angle lead to the early detection of the unstable driving state. So it is possible to minimize a risk of erroneous detections, for example due to measurement errors when ascertaining the actual steering angle. The method becomes more robust.

Preferably, if the actual steering angle deviates from the setpoint steering angle at least by a steering-angle tolerance value and a trajectory deviation is ascertained, the early detection of the unstable driving state includes: early detection of understeering of the vehicle if the trajectory deviation includes a lateral deviation directed toward the outside of a bend and a directional error directed toward the outside of a bend; and early detection of oversteering of the vehicle if the trajectory deviation includes a directional error directed toward the inside of a bend. The trajectory deviation preferably includes lateral deviation of the vehicle and/or a directional error of the vehicle. The directional error is an angle between a requested setpoint movement direction of the vehicle on the setpoint trajectory and a real movement direction of the vehicle. The directional error can be an error of the course angle. Preferably, the directional error is ascertained if the deviation between setpoint movement direction and real movement direction is 2° or more. The inside of a bend is the side of a bend on which the center point of the radius of curvature of the bend is located. The outside of a bend is the side opposite the inside of the bend. Preferably, the dimension of the deceleration of the at least one wheel is ascertained on the basis of the directional error and/or the lateral deviation if the unstable driving state is oversteering. For the case of oversteering, the dimension of the deceleration can preferably also be ascertained on the basis of a sideslip angle of the vehicle. The sideslip angle can for example and preferably be ascertained by integration on the basis of a time curve of the yaw rate and a movement direction of the vehicle. Preferably, the sideslip angle is ascertained on the basis of the yaw-rate deviation, particularly via temporal integration of the yaw-rate deviation.

In an embodiment, the countersteering angle is ascertained on the basis of directional errors directed toward the inside of a bend. Alternatively or additionally, the countersteering angle can also be ascertained on the basis of the sideslip angle.

Preferably, the vehicle is an at least semi-autonomous vehicle, wherein the ascertainment of the setpoint steering angle takes place via a position controller of the vehicle and wherein the steering of the vehicle takes place via a control unit of a vehicle control system as soon as an unstable driving state is detected. Preferably, the control unit of the vehicle control system takes over the electronically controllable steering system from the position controller as soon as an unstable driving state is detected. It may however also be provided that the control unit is part of the position controller or encompassed by the position controller. Furthermore, the control unit can also be a steering control unit of the vehicle. The control unit takes over the electronically controllable steering system if this provides steering requests at the controller, which are then executed by the steering system. The takeover can preferably take place by assigning a corresponding priority so that steering requests which are provided by the control unit are executed in preference to steering requests of the position controller.

Preferably, the definition of the steering angle correction takes place via the control unit of the vehicle control system. The steering angle correction is defined, in the event of an unstable driving state, by the unit which is also steering the vehicle. The method can thus be carried out particularly fast. Furthermore, it is ensured that the vehicle is steered using the steering angle correction. It may however also be provided that the steering angle correction is provided at the position controller and the position controller carries out the steering of the vehicle using the steering angle correction.

According to a further embodiment, the method further includes: ascertainment of whether a stable driving state of the vehicle is achieved and transfer of the electronically controllable steering system of the vehicle from the control unit of the vehicle control system to the position controller of the vehicle if or as soon as a stable driving state of the vehicle is achieved. The control unit of the vehicle control system takes over the steering of the vehicle as soon as an unstable driving state is detected. At a time prior to the detection of the unstable driving state, the vehicle is generally steered by the position controller. The control unit of the vehicle control system therefore preferably overrides the position controller of the vehicle as soon as an instability is present. As soon as the vehicle achieves a stable driving state again, the control unit of the vehicle control system according to the embodiment transfers the electronically controllable steering system of the vehicle to the position controller. A stable driving state is achieved if no more understeering or oversteering is present and/or if a trajectory deviation is within a tolerance corridor around the setpoint trajectory. Thus, a stable driving state may for example also not yet be achieved if although the vehicle is not under-or oversteering, it still has a lateral deviation from the driving path of the setpoint trajectory.

Preferably, the method includes a reduction of a motor torque of the vehicle in response to the early detection of the unstable driving state. The motor torque is a torque provided by a drive motor of the vehicle. The reduction of the motor torque acts in a stabilizing manner on the vehicle, so that returning the vehicle to a stable state is facilitated in the case of a reduced motor torque.

Furthermore, it is preferred that the vehicle is a road train having a towing vehicle and at least one trailer vehicle, wherein, in response to the early detection of the unstable driving state, the method further includes: braking the trailer vehicle, wherein the braking of the trailer vehicle preferably takes place based on an articulation angle between the towing vehicle and the trailer vehicle. Braking the trailer vehicle stabilizes the vehicle and jackknifing of the trailer vehicle can be prevented. Preferably, the trailer vehicle is braked in an isolated manner, so that anti-jackknifing braking is performed. Preferably, the trailer vehicle can also be decelerated in an alternative or supplementary manner, for example by recovering energy in a recuperator of the trailer vehicle.

In a second aspect, the disclosure achieves the object mentioned in the introduction via a vehicle control system for a vehicle, particularly a commercial vehicle, having a control unit which is configured to carry out the method according to the first aspect of the disclosure. Preferably, the vehicle control system as such can also be configured for carrying out the method according to the first aspect of the disclosure.

In a third aspect, the object mentioned in the introduction is achieved by a vehicle control system for a vehicle, particularly a commercial vehicle, having a control unit which can be connected to a virtual driver of the vehicle for the ascertainment of a setpoint trajectory for the vehicle and has an interface for connecting to an electronically controllable steering system of the vehicle; wherein the control unit is configured: to ascertain a setpoint steering angle for driving on the setpoint trajectory; to ascertain an actual variable of the vehicle and to ascertain oversteering or understeering of the vehicle at least using the actual variable and the setpoint trajectory; wherein the control unit is further configured to ascertain a steering angle correction for the setpoint steering angle in response to the early detection of the unstable driving state and to provide a controlled variable based on the steering angle correction and the setpoint steering angle at the interface for steering the vehicle, wherein the steering angle correction includes a steering-angle limitation of the steering angle that can be provided by the electronically controllable steering system if the unstable driving state is understeering of the vehicle, and wherein the steering angle correction includes a countersteering angle directed counter to the setpoint steering angle if the unstable driving state of the vehicle is oversteering. The setpoint steering angle can preferably also be encompassed by the setpoint trajectory.

It should be understood that the vehicle control method according to the first aspect of the disclosure and the vehicle control system according to the second aspect of the disclosure and/or the vehicle control system according to the third aspect of the disclosure have the same or similar sub-aspects. In this respect, reference is also made in full to the above description of the vehicle control method according to the first aspect of the disclosure for embodiments of the vehicle control system according to the second and/or third aspect of the disclosure. In particular, the vehicle control system according to the second aspect of the disclosure and/or the vehicle control system according to the third aspect of the disclosure is configured for carrying out the steps of the vehicle control method according to the first aspect of the disclosure.

In a fourth aspect, the object mentioned in the introduction is achieved by a vehicle, particularly a commercial vehicle, having an electronically controllable steering system, a virtual driver, which is configured to carry out trajectory planning to obtain a setpoint trajectory for the vehicle, and a vehicle control system according to the second aspect of the disclosure and/or according to the third aspect of the disclosure.

According to a fifth aspect of the disclosure, the object mentioned in the introduction is achieved by a computer program product having program code means, which are stored on a computer-readable data carrier, in order to execute the method according to the first aspect of the disclosure when the computer program product is executed on a computing unit. Preferably, the computing unit is a computing unit, particularly preferably the control unit, of a vehicle control system according to the second and/or third aspect of the disclosure.

### BRIEF DESCRIPTION OF DRAWINGS

The invention will now be described with reference to the drawings wherein:

FIG. 1 shows a vehicle;

FIG. 2A shows a vehicle that is understeering while driving through a bend;

FIG. 2B shows a vehicle that is oversteering while driving through a bend;

FIG. 3 shows a schematic flowchart which illustrates a first embodiment of a vehicle control method;

FIG. 4 shows a schematic flowchart which illustrates a second embodiment of a vehicle control method;

FIG. 5 shows a graph which, for understeering, illustrates a curve of a setpoint steering angle, an actual steering angle, a curvature of a bend, a lateral deviation of the vehicle, and a directional error of the vehicle along a driving path; and,

FIG. 6 shows a graph which, for oversteering, illustrates the curve of the setpoint steering angle, the actual steering angle, the curvature of the bend, the lateral deviation of the vehicle, and the directional error of the vehicle along the driving path.

### DETAILED DESCRIPTION

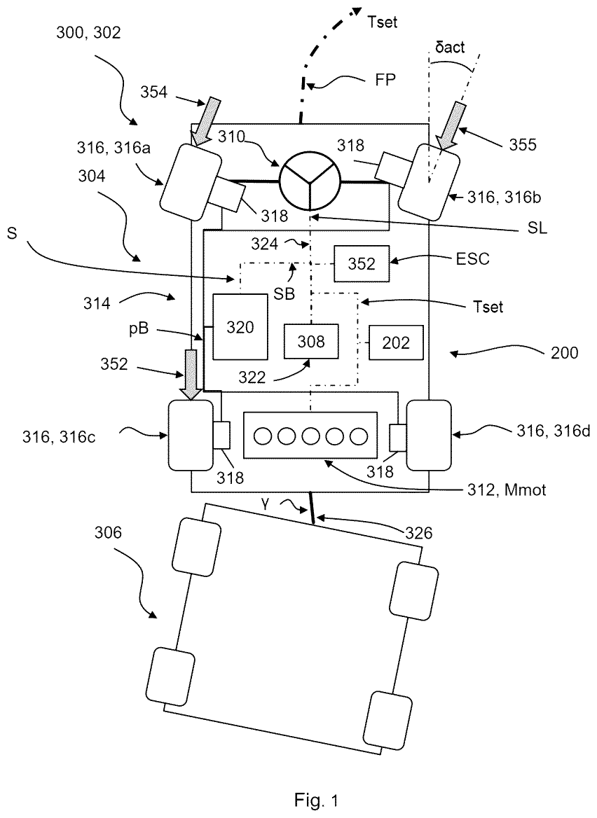

FIG. 1 shows a vehicle 300 which is configured as a road train 302 here. The road train 302, which is a commercial vehicle, includes a towing vehicle 304 which pulls a trailer vehicle 306. To control the vehicle 300, a virtual driver 308 is provided, which is configured to carry out trajectory planning to obtain a setpoint trajectory Tset for the vehicle 300. The setpoint trajectory Tset includes the driving path FP that is to be driven on by the vehicle 300, which driving path the vehicle 300 should follow according to the setpoint trajectory Tset.

The vehicle 300 further includes an electronically controllable steering system 310, a drive motor 312 and a braking system 314 which is provided for decelerating wheels 316 of the commercial vehicle 300. To decelerate the wheels 316, the braking system 314 has brake actuators 318 that are assigned to the wheels 316. The brake actuators 318 control brake slip of the wheels 316, which corresponds to a braking pressure pB that is provided at the brake actuators 318. The braking pressure pB is in turn provided by a brake modulator 320 of the braking system 314. The virtual driver 308 of the vehicle 300 is connected to the brake modulator 320 and provides braking signals SB to it. The brake modulator 320 receives the braking signals SB from the virtual driver 308 and controls corresponding braking pressures pB for the brake actuators 318. It should be understood that the braking pressures pB of the wheels 316 can vary. A braking pressure pB at a left front wheel 316a can therefore be different from a braking pressure pB which is provided at the brake actuator 318 which is assigned to a right front wheel 316b of the vehicle 300. Furthermore, the braking system 314 is also provided for decelerating the trailer vehicle 306, wherein only brake actuators 318 of the towing vehicle 304 are illustrated in FIG. 1.

In addition to trajectory planning, the virtual driver 308 of the vehicle 300 shown in FIG. 1 is configured as a position controller 322. The virtual driver 308 controls the vehicle 300 along the driving path FP encompassed by the setpoint trajectory Tset in a regular driving situation. For this, the virtual driver 308 activates the drive motor 312, the braking system 314 and the electronically controllable steering system 310 in such a manner that the vehicle 300 follows the driving path FP with a setpoint speed Vset that is encompassed by the setpoint trajectory Tset, wherein the setpoint speed Vset can vary along the driving path FP or can represent a speed profile. The virtual driver 308, the electronically controllable steering system 310, a motor control unit of the drive motor 312, which is not illustrated in FIG. 1, and the brake modulator 320 of the braking system 314 are connected via a vehicle network 324. To control the vehicle 300, the virtual driver 308 provides signals on the vehicle network 324, which can then be received by the other units of the vehicle 300. The vehicle network 324 here is a bus system, namely a CAN bus of the commercial vehicle 300.

The electronically controllable steering system 310 receives steering signals SL that are provided by the virtual driver 308 and steers the vehicle 300 in accordance with these steering signals SL. For this, in normal service, the electronically controllable steering system 310 sets an actual steering angle δact, which corresponds to the steering signals SL provided by the virtual driver 308, at the front wheels 316a, 316b of the towing vehicle 304. Simultaneously, the virtual driver 308 controls the longitudinal acceleration of the vehicle 300 via corresponding signals to the drive motor 312 and the braking system 314.

The towing vehicle 304 and the trailer vehicle 306 are connected via a drawbar 326, wherein the trailer vehicle 306 does not have its own drive here and is pulled by the towing vehicle 304. The trailer vehicle 306 follows the towing vehicle 304, wherein an articulation angle γ is set between the towing vehicle 304 and the trailer vehicle 306. During stationary driving in a straight-lined direction, the articulation angle γ has a value of 0°, as the trailer vehicle 306 is traveling in a straight line behind the towing vehicle 304. FIG. 1 shows an articulation angle γ of greater than 0° between the towing vehicle 304 and trailer vehicle 306.

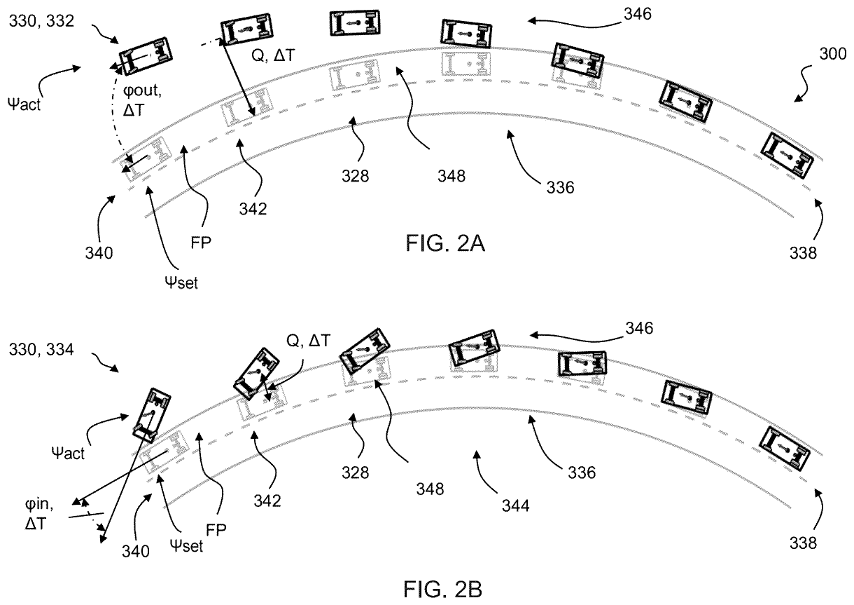

During stable driving, only the virtual driver 308 is controlling the fully autonomous vehicle 300 shown in FIG. 1. In certain situations however, the vehicle 300 may become unstable and not exhibit the handling characteristics that are assumed in the context of the trajectory planning. This is often the case if the vehicle 300 is loaded in an unfavorable manner or if road conditions are poor. Loading is unfavorable for example if the trailer vehicle 306 is fully loaded while the towing vehicle 304 is empty. In this case, the vehicle 300 has a tendency toward instabilities, as the trailer vehicle 306 can push the towing vehicle 304 from behind. Furthermore, a deviation between the assumed handling characteristics and real handling characteristics may for example be present if a loading situation of a trailer vehicle 306 that is configured as a semi-trailer leads to an increased rear-axle load of a towing vehicle 304 that is configured as a semi-trailer truck and thus causes understeering handling characteristics. Furthermore, poor road conditions, such as for example a slippery road or reduced friction between tires of the vehicle 300 and a roadway 328 (cf. FIGS. 2A, 2B) owing to oil on the road, sand or loose gravel, may lead to the vehicle 300 not being able to follow the driving path FP encompassed by the setpoint trajectory Tset.

Two unstable driving states 330 which may become established in the course of cornering of the vehicle 300 are understeering 332 and oversteering 334 of the vehicle 300. FIG. 2A and FIG. 2B illustrate these unstable driving states 330 on the basis of a vehicle 300 which is illustrated in a simplified manner and is driving through a bend 336 (left-hand bend). FIG. 2A shows understeering 332 of the vehicle 300, while FIG. 2B illustrates oversteering 334 of the vehicle 300.

In FIG. 2A, the vehicle 300 is driving through the bend 336 from right to left. A start 338 of the bend is therefore illustrated close to the right edge of the image, while an end 340 of the bend is arranged close to the left edge of the image. FIG. 2A shows the vehicle 300 in the unstable driving state 330, which is superimposed on the vehicle 300 in a stable driving state 342, in which the vehicle 300 is following the setpoint trajectory Tset in an ideal manner. In the stable driving state 342, the vehicle 300 is illustrated with less contrast compared to the unstable driving state 330. When driving into the bend 336, the stable driving state 342 and the unstable driving state 330 are still identical. In the unstable case, the vehicle 300 cannot follow the course of the bend 336 or the setpoint trajectory Tset. In the case of understeering 332, the vehicle 300 deviates toward the outside 346 of the bend from the planned driving path FP, which corresponds exactly to the course of the bend 336. A lateral offset Q of the vehicle 300 to the driving path FP or to the setpoint trajectory Tset increases continuously from entry 338 to the bend to exit 340 from the bend. An actual yaw rate Ψact of the vehicle 300 is less than a setpoint yaw rate Ψset, so the vehicle 300 turns less strongly into the bend 336 than is desired to follow the setpoint trajectory Tset. A directional error ϕ between the orientation of the vehicle 300 in the case of understeering 332 and the vehicle 300 driving in a stable manner increases toward the exit 340 from the bend.

FIG. 2B illustrates an oversteering vehicle 300. The vehicle 300 in the case of oversteering 334 is likewise superimposed on a vehicle 300 in a stable driving state 342 (illustrated with lower contrast in FIG. 2B) here. In the case of oversteering 334, the vehicle 300 turns in more strongly than would be necessary for the current driving path FP. Even if the actual steering angle δ of the vehicle 300 is less than a setpoint steering angle δset or even points in the opposite direction, the actual yaw rate Ψact of the vehicle 300 in the case of oversteering 334 exceeds the setpoint yaw rate Ψset that would be necessary for driving on the bend 336. The directional error ϕ likewise increases continuously from entry 338 to the bend toward the exit 340 from the bend in the case of oversteering 334, but has a different sign compared to understeering 332. So, a front of the vehicle 300 points further toward the inside 344 of the bend in the case of oversteering 334 than in the stable driving state 342, whereas the front of the vehicle 300 is directed further in the direction of the outside 346 of the bend in the case of understeering 332 than in the stable driving state 342. Owing to the excessive actual yaw rate Ψ compared to the setpoint yaw rate Ψset, the rear end of the vehicle 300 breaks away in the case of oversteering 334. In the embodiment according to FIG. 2B, a lateral deviation Q of the vehicle 300 also increases toward the outside 346 of the bend.

The virtual driver 308 continuously monitors a situation 348 of the vehicle 300. The situation 348 includes both a position and an orientation of the vehicle. As soon as the virtual driver 308 detects a trajectory deviation ΔT, the virtual driver 308 attempts to guide the vehicle 300 back onto the driving path FP of the setpoint trajectory Tset via corresponding control interventions. Without the method 1 according to the disclosure, the virtual driver 308 would continuously increase the actual steering angle δact of the vehicle 300 in the case of oversteering 332 (FIG. 2B) in order to compensate the lateral deviation Q of the vehicle 300 toward the outside 346 of the bend. The greater the lateral deviation Q of the vehicle 300 becomes, the faster the virtual driver 308 would increase the actual steering angle δact. As soon as this adjustment of the actual steering angle δact by the virtual driver 308 exceeds a predefined rate of change (that is, change of the actual steering angle δact per unit time), a stability control system 350 of the commercial vehicle 300 intervenes in a stabilizing manner. The stability control system 350 is an electronic stability control ESC here, which is connected to the vehicle network 324 (cf. FIG. 1). The ESC provides braking signals SB on the vehicle network 324, which cause the braking system 314 of the vehicle 300 to set a braking pressure pB at the braking actuator 318 which is assigned to the front wheel 316b of the vehicle 300 on the outer side of the bend. The brake actuator 318 decelerates the right front wheel 316b. This deceleration is illustrated in FIG. 1 by the arrow 355.

The ESC is an emergency system which only intervenes in a controlling manner in the driving operation of the commercial vehicle 300 if very large instabilities occur. Interventions of the ESC in the stable driving state 342 must be avoided, since these would impair the safety of the vehicle 300 considerably and could lead to accidents. The intervention threshold of the ESC is therefore chosen to be very high, so that only large instabilities of the vehicle 300 lead to an intervention of the ESC. The intervention thresholds of the ESC, which are chosen to be high, mean that a stabilizing intervention of the ESC only takes place late, for example if the vehicle 300 already has a very large lateral deviation Q from the driving path FP of the setpoint trajectory Tset. The late intervention of the ESC holds the risk however that the vehicle strays from the roadway 328 and/or collides with an obstacle owing to the increased space requirement. Also, in the case of oversteering 334, the ESC intervenes only late, as erroneous interventions, which may result from measurement errors for example, must be avoided. If no further system is provided, it is incumbent upon the virtual driver 308 to compensate a trajectory deviation ΔT, which here is the lateral deviation Q and the directional error ϕ, which entails the previously mentioned disadvantages.

The vehicle 300 therefore additionally includes a vehicle control system 200 which has a control unit 202, which here is likewise connected to the vehicle network 324. The control unit 202 is configured to provide braking signals SB for the braking system 314 and steering signals SL on the vehicle network 324. Furthermore, the control unit 202 of the vehicle control system 200 receives the setpoint trajectory Tset from the vehicle network 324, wherein the setpoint trajectory Tset is provided by the virtual driver 308 on the vehicle network 324. In alternative variants, the vehicle control system 200 or its control unit 202 can however also be part of the virtual driver 308.

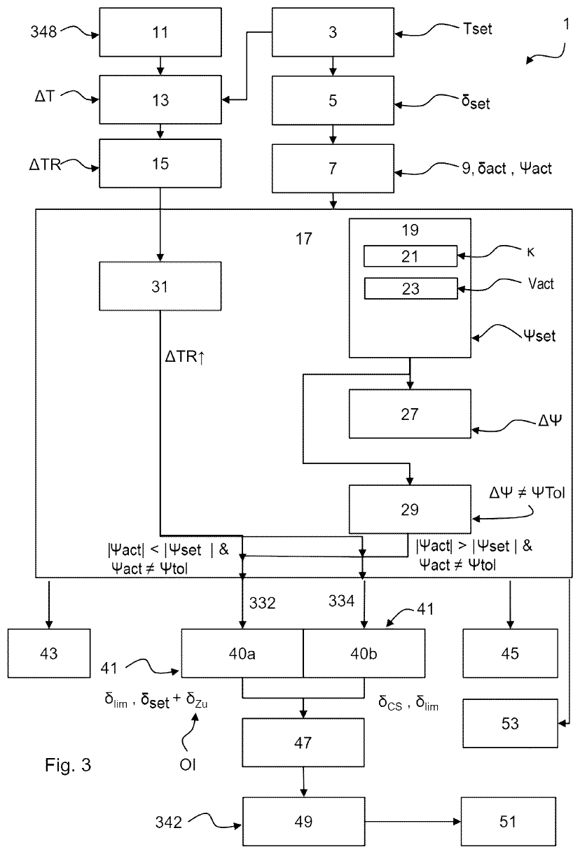

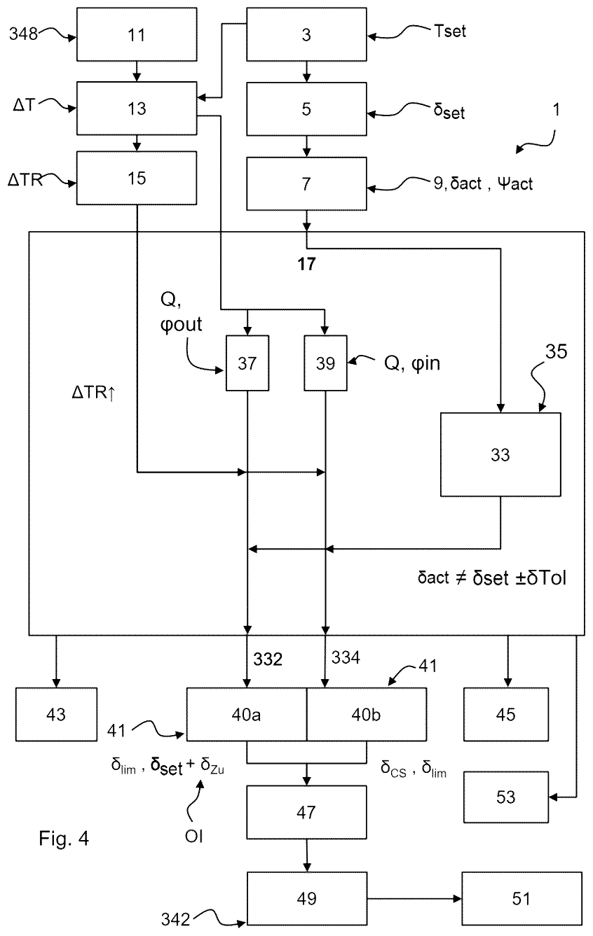

The vehicle control system 200 is configured to execute the vehicle control method 1 that is explained below with reference to FIG. 3 and FIG. 4. In a first step of the method 1, the vehicle control system 200 ascertains, in the context of an ascertainment 3, the setpoint trajectory Tset for the vehicle 300. Here, the ascertainment 3 takes place in that the vehicle control system 200 receives the setpoint trajectory Tset that is planned by the virtual driver 308 from the vehicle network 324. Subsequent to the ascertainment 3 of the setpoint trajectory Tset, ascertainment 5 of the setpoint steering angle δset follows. In the vehicle 300 according to FIG. 1, the setpoint steering angle δset is encompassed by the setpoint trajectory Tset. It may however also be provided that the electrically controllable steering system 310 ascertains the setpoint steering angle δset from the setpoint trajectory Tset, for example in that the electrically controllable steering system 310 calculates the setpoint steering angle δset from the curvature of the driving path FP and prestored geometric dimensions of the vehicle 300.

In a further step, at least one actual variable 9 is ascertained (ascertainment 7 in FIG. 3 and FIG. 4). In the embodiment of the vehicle control method 1 shown, the actual steering angle δact and the actual yaw rate Ψact of the vehicle 300 are determined while driving through the bend 336. The ascertainment 7 of the actual variables 9 takes place here on the basis of signals S, which are provided on the vehicle network 324. So, for example, the ESC provides a signal S representing the actual yaw rate Ψact on the vehicle network 324, from which the control unit 302 of the vehicle control system 200 determines the actual yaw rate Ψact in the context of the ascertainment 7. It may however also be provided that the vehicle control system 200 has a yaw rate sensor and/or a steering angle sensor. In the embodiment shown, the ascertainment steps 3, 5, 7 take place sequentially. It may however also be provided that the ascertainment 7 of the actual variable 9, the ascertainment 3 of the setpoint trajectory Tset and/or the ascertainment 5 of the setpoint steering angle take place entirely or partially simultaneously or that the ascertainment 7 takes place prior to the ascertainment 5 or the ascertainment 3.

Simultaneously to the ascertainment 3, 5, 7 of the setpoint trajectory Tset, the setpoint steering angle δset and the actual variables 9, monitoring 11 of the situation 348 of the vehicle 300 takes place. The virtual driver 308 monitors the situation 348 of the vehicle 300 continuously and provides corresponding signals S on the vehicle network 324. The control unit 202 of the vehicle control system 200 receives these signals S, so information corresponding to the situation 348 can also be processed by the control unit 202. In addition, using the setpoint trajectory Tset and the situation 348, the virtual driver 308 of the vehicle 300 ascertains the trajectory deviation ΔT of the vehicle 300 from the setpoint trajectory Tset (ascertainment 13 in FIG. 3 and FIG. 4). The trajectory deviation ΔT is also encompassed by the signals S and available at the control unit 202. It may however also be provided that the control unit 202 carries out the monitoring 11 of the situation 348 and/or the ascertainment 13 of the trajectory deviation ΔT. Using the trajectory deviation ΔT, the control unit 202 ascertains a rate of change of trajectory deviation ΔTR (ascertainment 15 in FIG. 3 and FIG. 4). The rate of change of trajectory deviation ΔTR characterizes the change over time of the trajectory deviation ΔT. If the rate of change of trajectory deviation ΔTR increases, the trajectory deviation ΔT of the situation 348 of the vehicle 300 from the setpoint trajectory Tset increases. If the rate of change of trajectory deviation ΔTR is falling, the trajectory deviation ΔT is conversely reduced, so the vehicle 300 approaches the setpoint trajectory Tset in this case.

Subsequent to the ascertainment 15 of the rate of change of trajectory deviation ΔTR and the ascertainment 7 of the actual variables 9, early detection 17 of an unstable driving state 330 of the vehicle 300 takes place. In the vehicle control method 1 according to FIG. 3, the early detection 17 of the unstable driving state 300 takes place via a yaw-rate-based approach, while FIG. 4 illustrates a steering-angle-based approach of the method 1. Preferably however, the method 1 includes both approaches. As a result of this, an unstable driving state 300 can be predicted particularly reliably via the vehicle control method 1.

In the yaw-rate-based approach according to FIG. 3, the early detection 17 initially includes ascertainment 19 of a setpoint yaw rate Ψset. The control unit 202 ascertains the setpoint yaw rate Ψset here based on the setpoint trajectory Tset. For this, the control unit 202 initially ascertains 21 a curvature K of the setpoint trajectory Tset, wherein the curvature K here is the curvature K of the bend 336. Furthermore, the control unit 202 ascertains an actual speed Vact with which the vehicle 300 is driving through the bend 336 (ascertainment 23 in FIG. 3). After the ascertainment 21, 23, 25 of the curvature k and the actual speed Vact, the control unit 202 ascertains the setpoint yaw rate Ψset from these variables.

From the setpoint yaw rate Ψset, which is ascertained using the setpoint trajectory Tset, and the real yaw rate Ψact, which occurs while driving through the bend 336, the control unit 202 of the vehicle control system 200 ascertains a yaw rate difference ΔΨ between the actual yaw rate Ψact and the setpoint yaw rate Ψset in a further step of the vehicle control method 1 (ascertainment 27 in FIG. 3). The yaw rate difference ΔΨ is a measure for an intensity of the unstable driving state 330. So the yaw rate difference ΔΨ in the case of oversteering 334 is particularly large if the vehicle 300 turns toward the inside 344 of the bend considerably faster than desired. The yaw rate difference ΔΨ is used in a later step of the method 1 in order to ascertain the intensity of deceleration 43 of a wheel 16 of the vehicle 300, but does not absolutely have to be ascertained for the early detection 17 of the unstable driving state 330. In the embodiment of the method 1 that is shown, for the early detection 17 of the unstable driving state 330 (ascertainment 29 in FIG. 3), it is ascertained whether the magnitude of the actual yaw rate Ψact is within a yaw-rate tolerance range Ψtol around the setpoint yaw rate Ψset. If the ascertainment 29 shows that the magnitude of the actual yaw rate Ψact is outside the yaw-rate tolerance range Ψtol and that the magnitude of the actual yaw rate Ψact is less than the magnitude of the setpoint yaw rate Ψset, then it is possible to ascertain understeering 332 of the vehicle 300. If the magnitude of the actual yaw rate Ψact is outside the yaw-rate tolerance range Ψtol and the magnitude of the actual yaw rate Ψact is greater than the magnitude of the setpoint yaw rate Ψset, then it is conversely possible to ascertain oversteering 334 of the vehicle 300.

The early detection 17 of the unstable driving state 330 could take place solely based on the previously described yaw-rate-based approach. However, in order to increase the robustness of the method 1 and to avoid erroneous detections of unstable driving states 330, the early detection 17 in the embodiment of the method according to FIG. 3 further takes the rate of change of trajectory deviation ΔTR into consideration. So, ascertainment 31 of whether the trajectory deviation ΔTR is increasing further takes place simultaneously to the previously described steps 19, 21, 23, 25, 27, 29. If this is the case, a trajectory deviation ΔT of the vehicle 300 from the setpoint trajectory Tset is therefore increasing in the course of the bend 336 and an unstable driving state 330 is detected. By taking the rate of change of trajectory deviation ΔTR into consideration, unstable driving states 330 are only detected early if a trajectory deviation ΔT develops from an unstable driving state 330. If, conversely, the trajectory deviation ΔT is due to other causes, then no unstable driving state 330 is detected. This is the case for example if the vehicle 330 has a lateral deviation Q from the setpoint trajectory Tset toward the outside 346 of the bend already at the start 338 of the bend. In a situation of this type, the virtual driver 308 will attempt to compensate the lateral deviation Q in that an actual steering angle δact is set between the start 338 of the bend and the end 340 of the bend, which is greater than the setpoint steering angle δset that is ascertained from the setpoint trajectory Tset. As a consequence, compared to the normal case without lateral deviation Q at the start 338 of the bend, the actual yaw rate Ψact is also greater than the corresponding setpoint yaw rate Ψset. The ascertainment 29 indicates oversteering 334 of the vehicle 300, since the magnitude of the actual yaw rate Ψact is greater than the magnitude of the setpoint yaw rate Ψset. Since the vehicle 300 is simultaneously approaching the setpoint trajectory Tset or the driving path FP however, the trajectory deviation ΔT is reducing and the rate of change of trajectory deviation ΔTR characterizes a decreasing trajectory deviation ΔT. Consequently, in this special case, no oversteering 334 is ascertained. Analogously, in spite of a magnitude of the actual yaw rate Ψact which is less than a magnitude of the setpoint yaw rate Ψset, no understeering 332 is ascertained if the trajectory deviation ΔT is decreasing. This is the case in particular if the vehicle 300 drives into the bend 336 already having a lateral deviation Q toward the inside 344 of the bend.

FIG. 4 illustrates the steering-angle-based approach to early detection 17 of an unstable driving state 330. In the steering-angle-based approach, a comparison is carried out (carrying out 33 in FIG. 4) of the actual steering angle δact, which is set by the virtual driver 308 at the vehicle 300 when driving through the bend 336, with the setpoint steering angle δset, which is ascertained beforehand on the basis of the setpoint trajectory Tset. If the actual steering angle δact deviates by more than a steering angle tolerance value δtol from the setpoint steering angle δset, an unstable driving state 330 can be detected early, as this indicates that the virtual driver 308 is attempting to compensate a trajectory deviation ΔT. The steering angle tolerance value δtol ensures that even the smallest deviations of the actual steering angle δact from the setpoint steering angle δset do not lead to the early detection 17 of an unstable driving state 330. For the same reason, in the first embodiment of method 1 according to FIG. 3, the yaw-rate tolerance range Ψtol is taken into consideration.

Also, in the second embodiment of the method 1 according to FIG. 4, the comparison 33 takes place in a magnitude-based manner. So, when carrying out 33 the variance comparison 35 between the actual steering angle δact and the setpoint steering angle δset, it is ascertained whether the magnitude of the actual steering angle δact is greater or less than the magnitude of the setpoint steering angle δset. The magnitude-based comparison offers the advantage that the vehicle control method 1 can be used, preferably without changes, both for left-hand bends and for right-hand bends.

Both in the case of understeering 332 and in the case of oversteering 334 of the vehicle 300, it is probable that the vehicle 300 is carried out of the bend 336 toward the outside 346 of the bend and as a consequence, a lateral deviation Q of the vehicle 300 from the setpoint trajectory Tset is set, which is directed toward the outside 346 of the bend. To compensate this lateral deviation Q, the virtual driver 308 will attempt, both in the case of understeering 332 and in the case of oversteering 334, to increase the actual steering angle δact beyond the setpoint steering angle δset. To differentiate between oversteering 334 and understeering 332, the method 1 according to the second embodiment further uses the ascertained trajectory deviation ΔT. For the case that the trajectory deviation ΔT includes a lateral deviation Q of the vehicle 300 from the setpoint trajectory Tset, which is directed toward the outside 346 of the bend, and a directional error ϕout, which is directed toward the outside 346 of the bend, understeering 332 of the vehicle 300 is detected early (early detection 37 in FIG. 4). If conversely, in the case of a lateral deviation Q of the vehicle 300 toward the outside 346 of the bend, a directional error ϕin toward the inside 344 of the bend is ascertained, an early detection 39 of oversteering 334 takes place. In the case of oversteering 334, the vehicle 300 turns more strongly toward the inside 344 of the bend than desired, which results in the directional error ϕin which is directed toward the inside 344 of the bend.

Analogously to the first embodiment of the vehicle control method 1 according to FIG. 3, the early detection 37, 39 via the rate of change of trajectory deviation ΔTR is also verified in the vehicle control method 1 according to FIG. 4. Thus, in the method according to FIG. 4 also, an unstable driving state 330 is only detected early if the rate of change of trajectory deviation ΔTR characterizes an increasing trajectory deviation ΔT.

Subsequent to the early detection 17 of an unstable driving state 330, the two embodiments of the vehicle control method 1 are substantially identical. In response to the early detection 17 of the unstable driving state 330, definition 39 of a steering angle correction 41 takes place in both embodiments of the vehicle control method 1 according to the disclosure. For the case of understeering 332 of the vehicle 300, the defined steering angle correction 41 is a steering-angle limitation δlim of the actual steering angle δact that can be provided by the electronically controllable steering system 310. The steering-angle limitation δlim therefore limits the actual steering angle δact which can be provided to a maximum value. The steering-angle limitation δlim corresponds here to the setpoint steering angle δset plus a steering-angle supplement δzu. For the case of oversteering 334 of the vehicle (illustrated as definition 40b in FIG. 3 and FIG. 4), the steering angle correction 41 is a countersteering angle δcs. The countersteering angle δcs is directed counter to the setpoint steering angle δset and points toward the outside 346 of the bend. The size of the counter steering angle δcs is preferably defined based on an intensity of the unstable driving state 330. Thus, in the case of an intense instability—which may for example be characterized by a large yaw rate difference ΔΨ and/or by a large deviation between actual steering angle δact and setpoint steering angle δset—a large countersteering angle δcs is preferably defined and vice versa.

The steering-angle limitation δlim corresponds to the setpoint steering angle δset plus the steering-angle supplement δzu. The steering-angle supplement δzu can be a prestored value. In the embodiments of method 1, the steering-angle supplement δzu is ascertained on the basis of surface information OI however. The surface information OI is encompassed by the setpoint trajectory Tset and represents adhesive properties of the roadway 328. The control unit 202 of the vehicle control system 200 receives the setpoint trajectory Tset and ascertains the surface information OI from that. The control unit 202 then uses this surface information OI in the definition 40a of the steering angle correction 40a in the case of understeering 332. So the steering-angle supplement δzu is comparatively low if the surface information OI represents a roadway 328 with low adhesion, since in such cases a further increase of the actual steering angle δact provides no further increase in the lateral guiding forces of the wheels 316 of the vehicle 300, even in the case of comparatively low absolute values. Conversely, in the case of a roadway with good adhesion or corresponding surface information OI, the steering-angle supplement δzu can be large, as even in the case of large actual steering angles δact, lateral guiding forces can still be provided.

Parallel to the definition 39 of the steering angle correction 41, an individual wheel deceleration 43 of a wheel 316 of the vehicle 300 takes place in both embodiments of the method 1. The individual wheel deceleration 43 is used to provide an additional yaw moment on the vehicle 300, in order to increase the actual yaw rate Ψact of the vehicle 300 in the case of understeering 332 or to reduce it in the case of oversteering 334. Preferably, the individual wheel deceleration 43 takes place during understeering 332 at a wheel of the vehicle 300 on the inner side of a bend, that is, the front wheel 316a or the rear wheel 316c for the bend 336 shown in FIG. 2A. The deceleration 43 in the case of understeering 332 is illustrated by arrows 352, 354. In the case of oversteering 334 by contrast, the wheel 316a on the outer side of a bend is preferably decelerated in order thus to provide a reversing moment on the vehicle 300, which counteracts the excessive actual yaw rate Ψact. The deceleration 43 of the outer front wheel 316b in the left-hand bend 336 according to FIG. 2B is illustrated in FIG. 1 by arrow 355. The individual wheel deceleration 43 preferably takes place on axles of the vehicle 300 unsymmetrically, so that a yaw moment is applied. The strength of deceleration of wheels 316 of axles of the vehicle 300 is therefore preferably different. Thus, in the case of understeering 332 for example, the wheel 316a can be decelerated, while the wheel 316b is not decelerated. A strength of the deceleration 43 of the at least one wheel 316 is ascertained on the basis of the yaw-rate deviation ΔΨ and/or on the basis of the deviation of the actual steering angle δact from the setpoint steering angle δset. So, for example in the case of oversteering 324 at the brake actuator 318 which is assigned to the front wheel 318b on the outer side of a bend (in the case of a left-hand bend 336), a particularly large braking pressure pB is set in the case of a large yaw-rate deviation ΔΨ, while a small braking pressure pB can be set in the case of a small yaw-rate deviation ΔΨ.

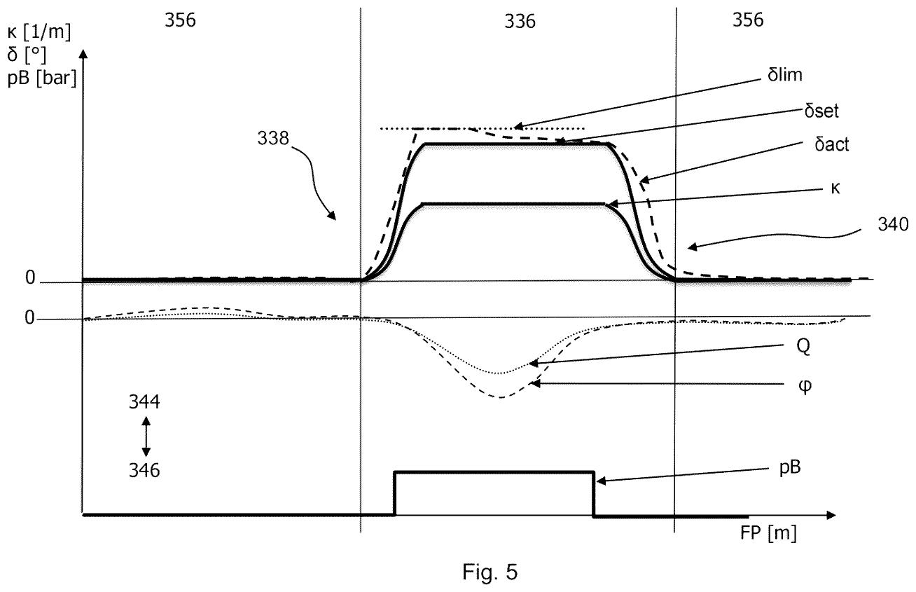

FIG. 5 shows a graph illustrating the influence on the vehicle 300 of the steering angle correction 41 and the deceleration 43, which is implemented in particular on an individual-wheel or per-axle basis, in the case of understeering 332. The graph illustrates the curve of the curvature k of the driving path FP, the setpoint steering angle δset, the actual steering angle δact, the lateral deviation Q and the directional error ϕ along the driving path, wherein the vehicle 300 drives on a straight-lined route section 356 before and after the bend 336 in each case. In the route section 356 located before the bend 336, the actual steering angle δact and the setpoint steering angle are equal to zero. The lateral deviation Q and the directional error ϕ of the vehicle 300 in the straight-lined route section 356 located before the bend 336 are likewise approximately equal to zero. Small fluctuations of the lateral deviation Q and the directional error ϕ in the straight-lined section 356 result from erroneous ascertainment of the situation 348 and possibly corrections of the virtual driver 308. At the start 338 of the bend, the actual steering angle δact increases approximately uniformly with the setpoint steering angle δset. The virtual driver 308 sets the actual steering angle δact via the electronically controllable steering system 310, in order to guide the vehicle 300 along the bend 336. FIG. 5 illustrates understeering 332 of the vehicle 300. An actual steering angle δact corresponding to the setpoint steering angle δset is not sufficient to guide the vehicle 300 along the bend 336. The lateral deviation Q toward the outside 346 of the bend and the directional error ϕ of the vehicle 300 toward the outside 346 of the bend increase, which can be seen in the two lower lines of the graph illustrated in FIG. 5. In order to compensate the lateral deviation Q, the virtual driver 308 increases the actual steering angle δact further and beyond a maximum of the setpoint steering angle δset. In the embodiment shown, a further increase of the actual steering angle δact is not expedient however, in order to compensate the lateral deviation Q and the directional error ϕ, as the vehicle 300 or its wheels 316 cannot provide any further lateral guiding forces owing to poor road conditions. A sudden improvement of the road conditions in the case of an excessive actual steering angle δact would lead to large lateral guiding forces being built up abruptly, as a result of which the vehicle 300 could start to skid. To prevent this, the steering-angle limitation Slim is defined in the method 1. FIG. 5 illustrates that the actual steering angle δact which can be provided at the active steering system 310 is limited owing to the steering-angle limitation δlim to a dimension that is slightly higher than the setpoint steering angle δset. The danger of a sudden instability of the vehicle owing to a change of the road conditions is thus eliminated. In order to compensate the lateral deviation Q and the directional error ϕ, a wheel 316 of the vehicle 300 on the inner side of the bend is decelerated at the same time as the steering-angle limitation δlim and a yaw moment is thus provided, as a result of which the vehicle 300 turns in toward the inside 344 of the bend. The deceleration is illustrated in FIG. 5 by the provision of a braking pressure pB. The lateral deviation Q of the vehicle 300 and its directional error ϕ decrease again. At the end 340 of the bend, the actual steering angle δact is reduced and the individual wheel deceleration 43 can be ended. Instead of decelerating an individual wheel 316, it is also possible in the case of understeering 332 for a per-axle deceleration to take place.

The individual wheel deceleration 43 and the steering angle correction 41 stabilize the vehicle 300 while driving through the bend 336. In addition, a motor torque Mmot of the drive motor 312 is reduced (reduction 45 in FIG. 3 and FIG. 4) in response to the early detection 17 of the understeering 332. As a result of this, the vehicle 300 is further stabilized.

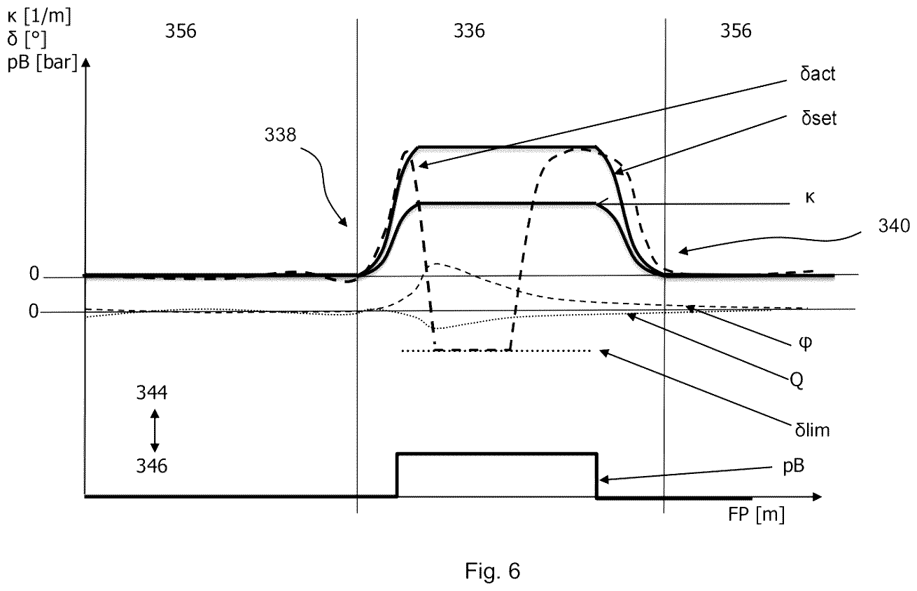

FIG. 6 shows, analogously to FIG. 5, a curve of the curvature k of the driving path FP, the lateral deviation Q of the vehicle 300, the directional error ϕ of the vehicle 300, the setpoint steering angle δset of the vehicle 300 when driving through the bend 336 and the setpoint steering angle δset of the vehicle 300 that is ascertained using the setpoint trajectory Tset. Unlike FIG. 5 however, FIG. 6 illustrates the curves of these variables for oversteering 334 of the vehicle 300 when driving through the bend 336. In the straight-lined route section 356, the steering angles δset, δact, the lateral deviation Q and the directional error ϕ are again essentially equal to zero. At the start 338 of the bend, the virtual driver 308 increases the actual steering angle δact substantially uniformly to the setpoint steering angle δset. As the vehicle 300 is understeering, the directional error ϕ increases toward the inside 344 of the bend. At the same time, the lateral deviation Q of the vehicle 300 increases in the direction of the outside 346 of the bend. To compensate this lateral deviation Q, the virtual driver 308 would increase the actual steering angle δact further in the direction of the inside 344 of the bend and thus amplify the oversteering 334 further. In the vehicle control method 1 however, the countersteering angle δcs is defined as steering angle correction 41 and superimposed on the setpoint steering angle δset. The countersteering angle δcs is directed counter to the setpoint steering angle δset, that is, points toward the outside 346 of the bend. The countersteering angle δcs is considerably greater than the setpoint steering angle δset here, so that an actual steering angle δact is set, which likewise points in the direction of the outside 346 of the bend. As a result of this, the understeering 334 is compensated and the vehicle 300 is stabilized. In addition to the countersteering angle δcs, the steering angle correction 41 in the case of oversteering 334 includes steering-angle limitation δlim. This steering-angle limitation Slim ensures that the countersteering angle δcs does not exceed a mechanical limit of the steering angle δ of approximately 45°. Thus, it is ensured that resetting of the actual steering angle δact in the direction of the inside 344 of the bend does not last too long and that mechanical limitations of the electronically controllable steering system 310 are complied with. As described previously, a reduction 45 of the motor torque Mmot of the drive motor 312 and individual wheel deceleration 43 of at least one wheel 316 (in the case of oversteering 334, preferably the front wheel on the outer side of the bend) of the vehicle 300 also take place in the case of oversteering 334 as additional stabilizing measures. The deceleration 43 is likewise illustrated in FIG. 6 by a curve of the braking pressure pB.

The graphs according to FIG. 5 and FIG. 6 illustrate that the vehicle 300 is steered using the steering angle correction 41 after the early detection 17 of an unstable driving state 330. This steering 47 is shown in the flowcharts for the first and second embodiments of the method 1 (cf. FIG. 3 and FIG. 4). In the vehicle 300, the control unit 202 of the vehicle control system 200 takes over the electronically controllable steering system 310 from the virtual driver 308 as soon as an unstable driving state 330 is detected early. To steer 47 the vehicle 300, the control unit 202 then provides steering signals SL on the vehicle network 324 and activates the electronically controllable steering system 310 using the steering angle correction 41. It may however also be provided that the control unit 202 provides the steering angle correction 41 for the virtual driver 308 and the virtual driver 308 carries out the steering 47 of the vehicle 300 using the steering angle correction 41.

In both variants, taking the steering angle correction 41 into consideration during the steering 47 of the vehicle 300 can be ensured for example via corresponding signal priorities. If the steering 47 of the vehicle 300 using the steering angle correction 41 in response to the early detection 17 of an unstable driving state 330 takes place via the virtual driver 308, the control unit 202 of the vehicle control system 200 can be configured in a comparatively simple and inexpensive manner. If however, the control unit 202 takes over the steering 47 using the steering angle correction 41 in response to the early detection 17 of an unstable driving state 330, then failure safety of the vehicle 300 is increased, as both the virtual driver 308 and the control unit 200 are configured for activating the electronically controllable steering system 310. Furthermore, a capacity to react can be increased, since the steering angle correction 41 is defined directly by the unit (the control unit 202) steering the vehicle 300. It should be understood that the control unit 202 can however also be configured for steering 47 if the steering 47 takes place in response to the early detection 17 by the virtual driver 308. Thus, the control unit 202 can for example steer the vehicle 300 using the steering angle correction 41 if the virtual driver 308 has a fault.

As has been explained previously, the control unit 202 steers the vehicle 300 according to FIG. 1 in response to the early detection 17 of an unstable driving state 330. The control unit 202 controls the vehicle 300 through the bend 336 and stabilizes the vehicle 300 in this case via the interaction of steering 47, reducing 45 the motor torque Mmot of the drive motor 312 and via the individual wheel deceleration 43. Furthermore, the control unit 202 causes the braking system 314 of the vehicle 300 to brake the trailer vehicle 306 (braking 53 in FIG. 3 and FIG. 4). The anti-jackknifing braking between towing vehicle 304 and trailer vehicle 306 that this achieves prevents jackknifing of the trailer vehicle 306. The intensity of the braking 53 is optionally ascertained by the control unit 202 using the articulation angle γ. Preferably, the trailer vehicle 306 is braked strongly in the case of a large articulation angle γ, that is, if the trailer vehicle 306 has an orientation that differs strongly from the towing vehicle 304. In the case of a small articulation angle γ, that is, if the trailer vehicle 306 is orientated essentially identically to the towing vehicle 304, a braking pressure pB at the brake actuators of the trailer vehicle 306 can be reduced.

After the vehicle 300 has driven through the bend 336, it again reaches a straight-lined route section 356. There, the vehicle 300 behaves in a stable manner. In the vehicle control method 1, an ascertainment 49 of a stable driving state 342 of the vehicle 300 therefore takes place. As a consequence of this ascertainment 49, the control unit 202 transfers the electronically controllable steering system 310 of the vehicle 300 back to the virtual driver 308, which here is also the position controller 322 of the vehicle 300 (transfer 51 in FIG. 3 and FIG. 4). Until the next early detection 17 of an unstable driving state 330, the steering system remains with the virtual driver 308.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 Vehicle control method
3 Ascertainment of a setpoint trajectory
5 Ascertainment of a setpoint steering angle
7 Ascertainment of an actual variable
9 Actual variable
11 Monitoring of a situation of the vehicle
13 Ascertainment of a trajectory deviation
15 Ascertainment of a rate of change of trajectory deviation
17 Early detection of an unstable driving state
19 Ascertainment of a setpoint yaw rate
21 Ascertainment of a curvature of the setpoint trajectory
23 Ascertainment of a setpoint speed
27 Ascertainment of a yaw rate difference
29 Ascertainment of whether the magnitude of the actual yaw rate is in a yaw-rate tolerance range
31 Ascertainment of whether the rate of change of trajectory deviation is increasing
33 Carrying out a comparison of actual steering angle and setpoint steering angle
35 Variance comparison
37 Early detection of understeering
39 Early detection of oversteering
40 Definition of a steering angle correction
40a Definition of a steering angle correction in the case of understeering
40b Definition of a steering angle correction in the case of oversteering
41 Steering angle correction
43 Individual wheel deceleration
45 Reduction of a motor torque
47 Steering
49 Ascertainment of a stable driving state
51 Transfer of the steering system
53 Braking a trailer vehicle
200 Vehicle control system
202 Control unit
300 Vehicle
302 Road train
304 Towing vehicle
306 Trailer vehicle
308 Virtual driver
310 Electronically controllable steering system
312 Drive motor
314 Braking system
316 Wheels
316a Left front wheel
316b Right front wheel
316c Left rear wheel
318 Brake actuator
320 Brake modulator
322 Position controller
324 Vehicle network
326 Drawbar
328 Roadway
330 Unstable driving state
332 Understeering
334 Oversteering
336 Bend
338 Start of the bend
340 End of the bend
342 Stable driving state
344 Inside of the bend
346 Outside of the bend
348 Situation
350 Stability control system
351 Arrow illustrating deceleration of a rear wheel on the inner side of the bend
352 Arrow illustrating deceleration of a rear wheel on the outer side of the bend
354 Arrow illustrating deceleration of a front wheel on the inner side of the bend
355 Arrow illustrating deceleration of a front wheel on the outer side of the bend
356 Straight-lined route section
ESC Electronic stability control
FP Driving path
Mmot Motor torque
OI Surface information
pB Braking pressure
SB Braking signals
SL Steering signals
Tset Setpoint trajectory
ΔT Trajectory deviation
ΔTR Rate of change of trajectory deviation
Δset Setpoint speed
γ Articulation angle
δact Actual steering angle
δset Setpoint steering angle
k Curvature
Ψact Actual yaw rate
Ψset Setpoint yaw rate
ΔΨ Yaw rate difference
ϕ Directional error
ϕ in Directional error directed toward the inside of the bend
ϕout Directional error directed toward the outside of the bend

1. A vehicle control method for a vehicle having an electronically controllable steering system, the vehicle control method comprising:
ascertaining a setpoint trajectory for the vehicle;
ascertaining a setpoint steering angle for driving on the setpoint trajectory;
ascertaining an actual variable of the vehicle;
making an early detection of an unstable driving state of the vehicle at least using the actual variable and the setpoint trajectory; ascertaining during early detection whether the unstable driving state is understeering of the vehicle or oversteering of the vehicle; and,
in response to the early detection of the unstable driving state:
defining a steering angle correction for the setpoint steering angle, wherein the steering angle correction includes a steering-angle limitation of an actual steering angle that can be provided by the electronically controllable steering system when the unstable driving state is understeering of the vehicle, and wherein the steering angle correction includes a countersteering angle directed counter to the setpoint steering angle when the unstable driving state of the vehicle is oversteering; and,
steering of the vehicle using the steering angle correction.

2. The method of claim 1, further comprising, in response to the early detection of the unstable driving state, individual wheel deceleration of at least one wheel of the vehicle.

3. The method of claim 1, wherein the steering-angle limitation corresponds to the setpoint steering angle plus a steering-angle supplement when the unstable driving state is understeering of the vehicle.

4. The method of claim 3, wherein the steering-angle supplement is ascertained using surface information of a roadway which is encompassed by the setpoint trajectory.

5. The method of claim 1, further comprising:
monitoring of a situation of the vehicle;
ascertaining a trajectory deviation of the vehicle using the setpoint trajectory and the monitored situation; and,
ascertaining a rate of change of trajectory deviation.

6. The method of claim 1, wherein the actual variable is an actual yaw rate and the early detection of the unstable driving state of the vehicle at least using the actual variable and the setpoint trajectory comprises:
ascertaining a setpoint yaw rate for the vehicle using the setpoint trajectory; and,
ascertaining the unstable driving state when the actual yaw rate is outside a yaw-rate tolerance range around the setpoint yaw rate.

7. The method of claim 6, wherein understeering of the vehicle is ascertained when the magnitude of the actual yaw rate is below the yaw-rate tolerance range and wherein oversteering of the vehicle is ascertained if the magnitude of the actual yaw rate is above the yaw-rate tolerance range.

8. The method of claim 5, wherein understeering or oversteering of the vehicle is only ascertained if the rate of change of trajectory deviation characterizes an increasing trajectory deviation of the vehicle from the setpoint trajectory.

9. The method of claim 8, wherein the ascertainment of the setpoint yaw rate for the vehicle using the setpoint trajectory comprises:
ascertaining a curvature of the setpoint trajectory;
ascertaining an actual speed of the vehicle; and,
ascertaining the setpoint yaw rate at least using the curvature of the setpoint trajectory and the actual speed of the vehicle.

10. The method of claim 6, wherein the yaw-rate tolerance range has a width of at least one of the following: ±0.1° /s to ±10° /s and ±0.5° /s to ±2° /s, around the setpoint yaw rate.

11. The method of claim 6, wherein the countersteering angle is ascertained using a yaw-rate deviation between the actual yaw rate and the setpoint yaw rate when the unstable driving state is oversteering.

12. The method of claim 5, wherein the actual variable is the actual steering angle and the early detection of the unstable driving state of the vehicle at least using the actual variable and the setpoint trajectory comprises:
carrying out a variance comparison between the actual steering angle and the setpoint steering angle; and,
early detection of the unstable driving state if a trajectory deviation is ascertained and the actual steering angle deviates from the setpoint steering angle at least by a steering-angle tolerance value.

13. The method of claim 12, wherein when the actual steering angle deviates from the setpoint steering angle at least by a steering-angle tolerance value and a trajectory deviation is ascertained, the early detection of the unstable driving state comprises:
making an early detection of understeering of the vehicle if the trajectory deviation comprises a lateral deviation directed toward an outside of a bend and a directional error directed toward the outside of the bend; and,
making an early detection of oversteering of the vehicle if the trajectory deviation comprises a directional error directed toward an inside of the bend.

14. The method of claim 13, wherein at least one of the following applies: i) the early detection of understeering; and, ii) the early detection of oversteering only takes place when the rate of change of trajectory deviation characterizes an increasing trajectory deviation of the vehicle from the setpoint trajectory.

15. The method of claim 13, wherein the countersteering angle is ascertained on the basis of directional errors directed toward the inside of the bend.

16. The method of claim 1, wherein the vehicle is an at least semi-autonomous vehicle, the ascertainment of the setpoint steering angle takes place via a position controller of the vehicle and the steering of the vehicle takes place via a control unit of a vehicle control system as soon as the unstable driving state is detected.

17. The method of claim 16, wherein the definition of the steering angle correction takes place via the control unit of the vehicle control system.

18. The method of claim 16, further comprising:
ascertaining whether a stable driving state of the vehicle is achieved; and,
transferring the electronically controllable steering system of the vehicle from the control unit of the vehicle control system to the position controller of the vehicle when a stable driving state of the vehicle is achieved.

19. The method of claim 1, further comprising, in response to the early detection of the unstable driving state, reduction of a motor torque of the vehicle.

20. The method of claim 1, wherein the vehicle is a road train having a towing vehicle and at least one trailer vehicle, wherein, in response to the early detection of the unstable driving state, the method further comprises:
braking the trailer vehicle, wherein the braking of the trailer vehicle takes place based on an articulation angle between the towing vehicle and the trailer vehicle.

21. A vehicle control system for a vehicle, the vehicle control system comprising:
a control unit configured to:
ascertain a setpoint trajectory for the vehicle;
ascertain a setpoint steering angle for driving on the setpoint trajectory;
ascertain an actual variable of the vehicle;
make an early detection of an unstable driving state of the vehicle at least using the actual variable and the setpoint trajectory; ascertaining during early detection whether the unstable driving state is understeering of the vehicle or oversteering of the vehicle; and,
in response to the early detection of the unstable driving state:
define a steering angle correction for the setpoint steering angle, wherein the steering angle correction includes a steering-angle limitation of an actual steering angle that can be provided by the electronically controllable steering system when the unstable driving state is understeering of the vehicle, and wherein the steering angle correction includes a countersteering angle directed counter to the setpoint steering angle when the unstable driving state of the vehicle is oversteering; and,
steer of the vehicle using the steering angle correction.

22. A vehicle comprising:
an electronically controllable steering system;
a virtual driver configured to carry out trajectory planning to obtain a setpoint trajectory for the vehicle;
a vehicle control system having a control unit which is configured to:
ascertain a setpoint trajectory for the vehicle;
ascertain a setpoint steering angle for driving on the setpoint trajectory;
ascertain an actual variable of the vehicle;
make an early detection of an unstable driving state of the vehicle at least using the actual variable and the setpoint trajectory; ascertaining during early detection whether the unstable driving state is understeering of the vehicle or oversteering of the vehicle; and,
in response to the early detection of the unstable driving state:
define a steering angle correction for the setpoint steering angle, wherein the steering angle correction includes a steering-angle limitation of an actual steering angle that can be provided by the electronically controllable steering system when the unstable driving state is understeering of the vehicle, and wherein the steering angle correction includes a countersteering angle directed counter to the setpoint steering angle when the unstable driving state of the vehicle is oversteering; and,
steer of the vehicle using the steering angle correction.

23. A computer program product comprising a program code stored on a non-transitory computer-readable medium, said program code being configured, when executed by a processor, to carry out the method of claim 1.
